(19) United States
(12) Patent Application Publication
(10) Pub. No.: US 2019/0383942 A1
(43) Pub. Date: Dec. 19, 2019

(54) LIDAR-ONLY LOCK-ON TRACKING SYSTEM

(71) Applicant: DSCG SOLUTIONS, INC., Chantilly, VA (US)

(72) Inventors: Kendall Belsley, Falls Church, VA (US); Richard Sebastian, Frederick, MD (US)

(21) Appl. No.: 16/442,122

(22) Filed: Jun. 14, 2019

Related U.S. Application Data
(60) Provisional application No. 62/686,289, filed on Jun. 18, 2018.

(51) Int. Cl. G01S 17/58; G01S 17/42; G01S 17/89; G01S 7/48

(52) U.S. Cl. CPC G01S 17/58; G01S 7/4808; G01S 17/89; G01S 17/42

(57) ABSTRACT

A tracking system uses multiple beams arranged in a pattern, or a signal-of-interest (SOI) array, such that the beams do not move appreciably relative to the target during data gathering. For example, a specified pattern of beams is arranged along portions of a rectangular grid and is projected onto a region of an object (e.g., a cheek of a human face). When the object moves, the tracking system receives an indication that the object has moved and obtains the object velocity along the beam direction. From this component of the velocity, the velocity in a lateral direction (i.e., orthogonal to the beam direction) is deduced. The tracking system then adjusts the pattern of beams to lock on the region of the object, based on this lateral velocity. This LIDAR-only tracking system is then a robust tracking system that in which there is little to no latency that video generates.

### RELATED APPLICATIONS

This application claims priority to U.S. Provisional Patent Application No. 62/686,289, filed Jun. 18, 2018, entitled “LIDAR-ONLY LOCK-ON TRACKING SYSTEM,” the disclosure of which is hereby incorporated by reference in its entirety.

### TECHNICAL FIELD

This description relates to tracking detection system including a multiple beam laser LIght Detection And Ranging (LIDAR) system.

### BACKGROUND

In some known LIDAR systems, lasers may be used to track objects. However, known LIDAR systems used in object tracking are often relatively slow, inefficient, and/or inaccurate. Thus, a need exists for systems, methods, and apparatus to address the shortfalls of present technology and to provide other new and innovative features.

### BRIEF DESCRIPTION OF THE DRAWINGS

FIG. 1 is a diagram illustrating an example improved LIDAR tracking system.

FIG. 2A is a diagram illustrating an example object being tracked within the LIDAR tracking system illustrated in FIG. 1.

FIG. 2B is a diagram illustrating the example object as tracked within the LIDAR tracking system illustrated in FIG. 1.

FIG. 2C is a diagram illustrating another example object being tracked within the LIDAR tracking system illustrated in FIG. 1.

FIG. 2D is a diagram illustrating the other example object as tracked within the LIDAR tracking system illustrated in FIG. 1.

FIG. 2E is a diagram illustrating the other example object as further tracked within the LIDAR tracking system illustrated in FIG. 1.

FIG. 3 is a diagram illustrating an example beam pattern on a target for use in the LIDAR tracking system described herein.

FIG. 4 is a diagram illustrating an example interpolation scheme on a central array of the beam pattern for use in the LIDAR tracking system described herein.

FIG. 5 is a flow chart illustrating a method for performing tracking of an object using the LIDAR tracking system described herein.

### DETAILED DESCRIPTION

Some conventional tracking systems use combinations of video and beams from LIDAR systems to determine the motion of a target. The ability to track motion using such tracking systems, however, is limited by the slow sampling of the video at 30 frames per second. Some other conventional tracking systems use beams exclusively. Nevertheless, such systems have difficulties acquiring consistently accurate results because of an inability to keep the beams on the target at all times.

In contrast to the above-described conventional tracking systems, an improved tracking system uses multiple beams arranged in a pattern, or a signal-of-interest (SOI) array, such that the beams do not move appreciably relative to the target during data gathering. For example, a specified pattern of beams is arranged along portions of a rectangular grid and is projected onto a region of an object (e.g., a cheek of a human face). When the object moves, the tracking system receives an indication that the object has moved and obtains the object velocity along the beam direction. From this component of the velocity, the velocity in a lateral direction (i.e., orthogonal to the beam direction) is deduced. The tracking system then adjusts the pattern of beams to lock on the region of the object, based on this lateral velocity. The improved LIDAR-only tracking system is then a robust tracking system that in which there is little to no latency that video generates.

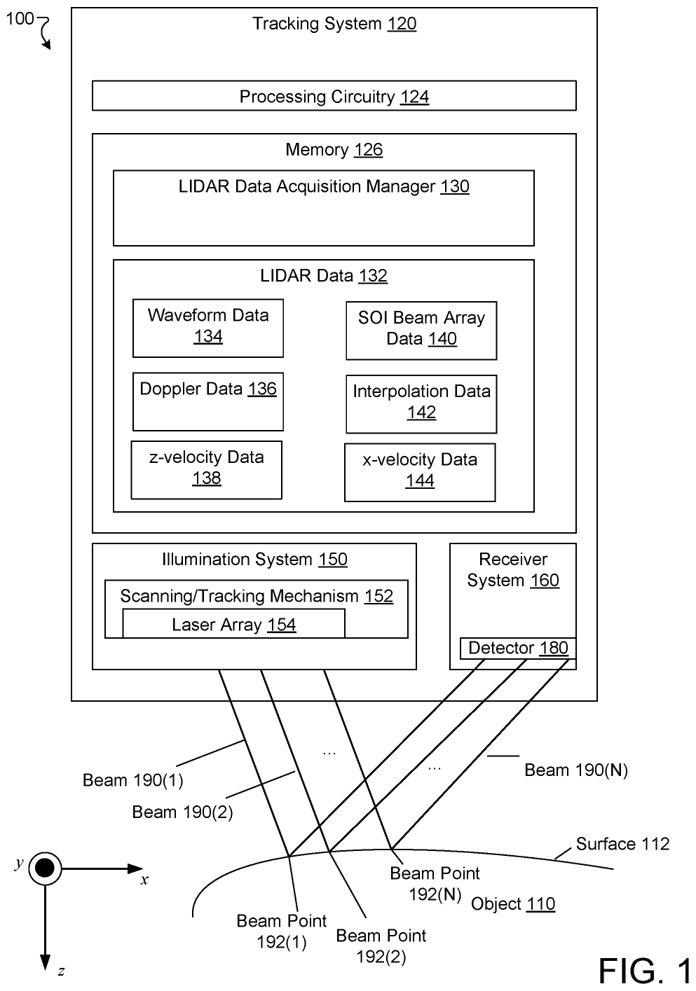

FIG. 1 is a diagram that illustrates an example electronic environment 100 in which improved techniques of tracking an object's motion are performed. The electronic environment 100 includes a tracking system 120 that is configured to track an object 110 in real time.

The object 110 is assumed herein to be a rigid body of some unknown shape. For example, the object 110 may be a human face. The object 110 is assumed to be in motion, both linear and rotational, about an arbitrary axis. It should be understood that in the electronic environment 100 shown in FIG. 1, there is a natural axis of symmetry that is seen to be substantially normal to the orientation of the object.

As shown in FIG. 1, the tracking system 120 is a single, integrated unit that includes processing circuitry 124, memory 126, an illumination system 150, and a receiver system 160. In some arrangements, the tracking system 120 takes the form of a handheld unit that may be pointed at the object 110. However, in other arrangements the components of the tracking system 120 may be distributed among different units (e.g., the processing circuitry 124 and memory 126 might be in a computing device separate from a handheld device that includes the illumination system 150 and the receiver system 160).

The processing circuitry 124 includes one or more processing chips and/or assemblies. The memory 126 includes both volatile memory (e.g., RAM) and non-volatile memory, such as one or more ROMs, disk drives, solid state drives, and the like. The set of processing units 124 and the memory 126 together form control circuitry, which is configured and arranged to carry out various methods and functions as described herein.

In some arrangements, one or more of the components of the tracking system 120 can be, or can include, processors configured to process instructions stored in the memory 126. For example, a LIDAR data acquisition manager 130 (and/or a portion thereof) shown as being included within the memory 126 in FIG. 1, can be a combination of a processor and a memory configured to execute instructions related to a process to implement one or more functions.

The LIDAR data acquisition manager 130 is configured to produce LIDAR data 132 in response to the detector 180 receiving beams of electromagnetic (EM) radiation (e.g., laser light) reflected from the object 110. In some arrangements, the LIDAR data 130 includes position data for the object 110 along the z-axis as defined in the coordinate system in FIG. 1 (i.e., out of the (x,y) plane as discussed above) and rotational velocity data for the object 110 about the x- and y-axes as defined in the coordinate system in FIG. 1.

The LIDAR data 132 includes data that controls the operation of the tracking system 132 and defines the motion of the object 110 being tracked. For example, the waveform data 134 represents a frequency pattern of the beams 190(1), . . . , 190(N) as they are transmitted. In one example, the frequency pattern may be a chirped frequency. Specifically, the frequency pattern may include an up-chirp followed by a down-chirp. In the up-chirp, the transmitted laser frequency increases linearly, and in the down-chirp the transmitted laser frequency decreases linearly. The chirp duration is 0.125 ms, so the target speed is sampled at an 8 kHz sampling rate. Differing target range and velocity will result in different beat frequencies. Measuring this frequency allows for measurement of the target range and velocity.

The Doppler data 136 represents the beat frequencies determined as a result of interference between the beams reflected off the target 110 and the transmitted beams. In some implementations, the LIDAR data acquisition manager 130 is also configured to perform post-processing operations (such as phase corrections) to accurately determine the beat frequency.

The z-velocity data 138 represents the longitudinal velocity of the object 110 (i.e., the z-velocity). This z-velocity data 138 may be determined from the beat frequencies acquired from the Doppler data 136.

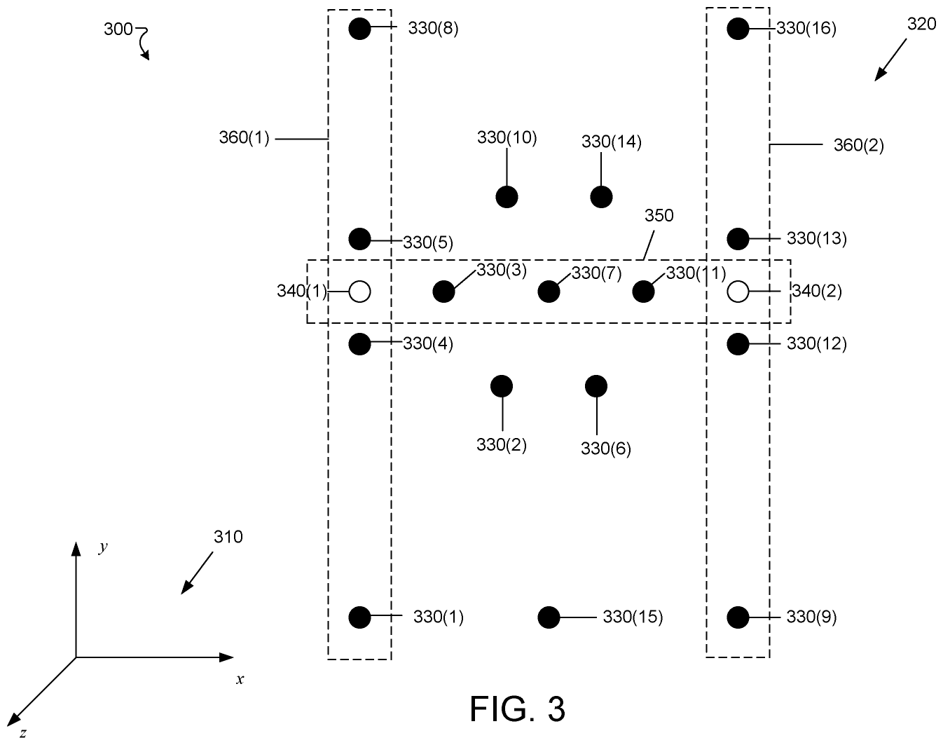

The SOI beam array data 140 represents a desired arrangement of the beams 190(1), . . . , 190(N) as they are incident on the target 110. Further detail on an example SOI array is shown with regard to FIG. 3.

The interpolation data 142 represents an approximation to a denser sampling of the position of the object 110 not afforded due to limitations on the number of beams N. In some implementations, the LIDAR data acquisition manager 130 is configured to perform an interpolation operation on the z-velocity data 138 to determine a more dense sampling of the z-velocities of points on the object 110. An example interpolated sampling density might take 5 points and use those to evaluate 30-50 points.

The x-velocity data 144 represents the transverse velocity of the object 110. The LIDAR data acquisition manager 130 is configured to produce the x-velocity data 144 from the rest of the LIDAR data 132. Once determined, the x-velocity data 144, along with the z-velocity data 138, essentially provides the tracking of the object 110.

The illumination system 150 is configured and arranged to produce the illumination that is reflected from the surface 112 of the object 110. As shown in FIG. 1, this illumination takes the form of multiple beams 190(1), . . . , 190(N) of radiation directed along the z-axis. The illumination system 150 includes a scanning mechanism 152, which includes a laser array 154, and an aperture 170.

The scanning/tracking mechanism 152 is configured and arranged to move the laser array 154 in a scanning and/or tracking motion. As shown in FIG. 1, the scanning/tracking mechanism 152 is configured to move each laser in the laser array 154 substantially along the x and y directions, i.e., orthogonally to the direction of the beams 190(1), . . . , 190(N). The scanning/tracking mechanism 152 moves the laser array 154 altogether, so that all movements are performed in one motion. For example, the scanning mechanism may include a single mirror that steers all beams 190(1), . . . , 190(N) simultaneously.

In some implementations, the scanning/tracking mechanism 152 is driven by feedback circuitry (not shown) that is configured to follow the object 110 as the object 110 moves. Such feedback circuitry would have, in some implementations, a fast enough response time to be able to keep the beams in roughly the same location on the object 110 over time.

The laser array 154 is configured and arranged to produce an SOI beam array (e.g., beams 190(1), . . . , 190(N)) of laser radiation, i.e., substantially coherent, quasi-monochromatic light. Each laser in the SOI array corresponds to a sample point on the surface 112 of the object 110 where the beam produced by that laser reflects off the surface 112. In some arrangements, the wavelength of the light in each beam 190(1), . . . , 190(N) produced by the laser array 154 is 1550 nm. This wavelength has the advantage of being suited to objects that are, for example, human faces. Nevertheless, other wavelengths (e.g., 1064 nm, 532 nm) may be used as well. Again, the arrangement of the array of beams is discussed in more detail with respect to FIG. 3.

The receiver system 160 is configured and arranged to receive the beams reflected from the surface 112 of the object 110 and generate the Doppler data 136 from the received beams. The receiver system 160 may generate the LIDAR data 132 using any number of known techniques (e.g., heterodyne detection) and will not be discussed further. The receiver system includes a detector 180 that is configured and arranged to convert the received beams into electrical signals from which the receiver system 160 may generate the LIDAR data 132. In some arrangements, the detector 180 includes a photomultiplier tube (PMT) or an array of charge-coupled devices (CCDs).

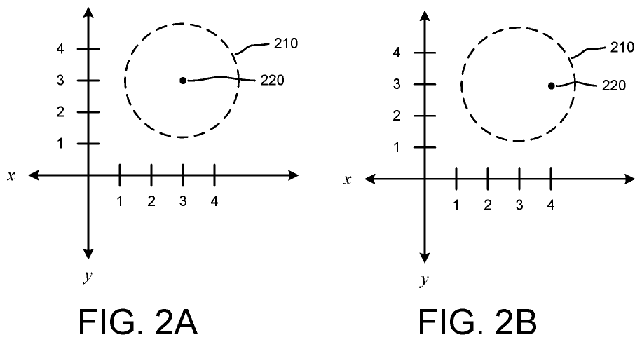

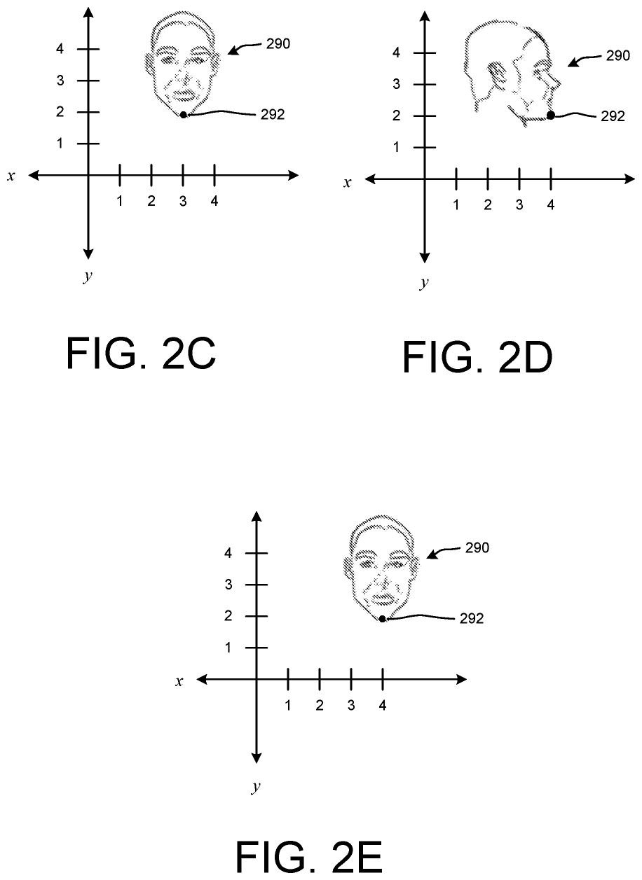

FIGS. 2A and 2B illustrate an example object 210 that may be observed by (e.g., targeted by) the tracking system 120. The object 210 may have any shape but is represented in FIGS. 2A and 2B as a circle. In FIG. 2A, at time T1 a point 220 on the object 210 is being observed by the tracking system 120. At time T1 the point 220 is located at (3,3) in the (x,y) plane. As illustrated in FIG. 2B, at time T2 the point 220 is located at (4,3) in the (x,y) plane. The movement of the point may be the result of different types of movements of the object 80. For example, the object 220 may have moved from one location to another (translational movement) or the object 220 may have rotated (for example, about an axis parallel to the y axis of the x-y plane).

As illustrated in FIGS. 2C, 2D, and 2E a head or face 290 of an individual may be tracked or observed by the tracking system 120. Specifically, a point or location 292 of the head or face 290 may be observed. As illustrated in FIG. 2C, at time T1 the point 292 is located at (3,2) in the (x,y) plane. At time T2 the point 292 may be observed to be at (4,2). The movement of the point may be the result of different types of motion. For example, the person or individual may have rotated their head (for example, about an axis parallel to the y axis), as illustrated in FIG. 2D. Alternatively, the person or individual may have moved their head (without any rotation), as illustrated in FIG. 2E.

FIG. 3 is a diagram illustrating an example SOI array 300 used in an improved tracking system. The SOI array 300 as shown in FIG. 3 includes a pattern of beams 320, including sixteen beams 330(1-16). Each of these beams are numbered according to positions in a pair of eight-beam columns has they been arranged in that fashion. In contrast, the beams 330(1-16) are arranged as follows: beams 330(1,4,5,8) are arranged in a line 360(1) parallel to the y-axis as shown in coordinate system 310, beams 330(9,12,13,16) are arranged in a line 360(2) parallel to the y-axis but displaced from line 360(1) along the x-axis as shown in coordinate system 310, and beams 330(2,3,6,7,10,11,14) are arranged in a hexagonal, seven-beam cluster in the center. (Beam 330(15) is arranged between beams 330(1) and 330(9).)

The SOI array 300 is arranged to help the beams 330(1-16) better track the target 110. Specifically, in some implementations and as shown in FIG. 3, a high-density (HD) array 350 consists of the center horizontal three beams of the seven-beam cluster, i.e., beams 330(3,7,11). Moreover, to allow information from off-axis beams to be included in the HD array 350, in some implementations, the tracking system 120 generates interpolated beams 340(1) and 340(2) based on, respectively, the beams 330(1,4,5,8) and the beams 330(9,12,13,16). In some implementations, the left and right synthesized beams are the respective average of the beams in the lines 360(1) and 360(2) surrounding the HD array 350.

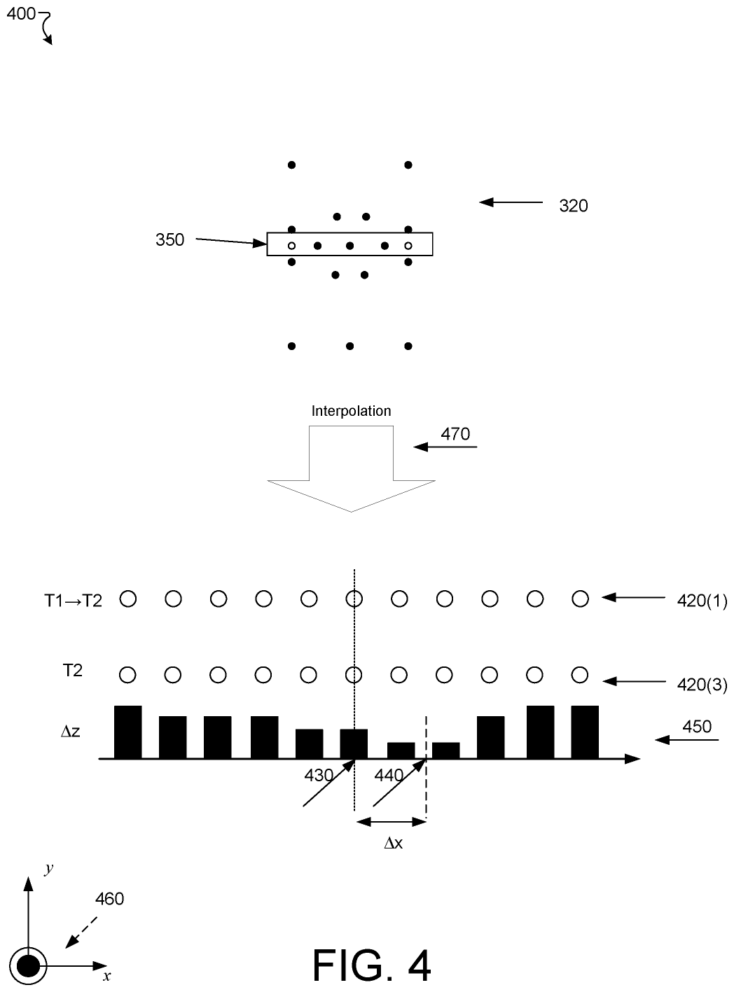

The z-velocity represented by the z-velocity data 138 and/or interpolation data 142 is estimated as the LIDAR range velocity. The z-velocity is adjusted for z-motion between previous and current sample times. The x-velocity represented by the x-velocity data 144 is found that minimizes the least squares z-distance between the adjusted z-velocity and the current z-velocity array. If the tracking is working correctly, the beam points (i.e., points of incidents on the object 110) will not have moved significantly on the target and the interpolated values 142 will be very close to the actual values. The tracking system 120 so configured may then lock the beams as defined in the SOI array 300 onto an object 110, e.g., a human face. In this way, one may deduce an audio signal from the x- and z-velocity data derived from the reflected beams. Further details of the deduction of the x-velocity data 144 from the z-velocity data 138 are provided with regard to FIG. 4.

FIG. 4 illustrates an example interpolation process used to determine the x-velocity of the object 110 (FIG. 1) using the pattern 320 and its center (HD) array 350, including interpolated beams 340(1,2) from beams of the lines 360(1,2).

When the object 110 moves between a time T1 and a time T2, the beams in the beam pattern 320 generate different beat signals at the detector due to the change in optical paths. This change is an indication to the tracking system that the object has moved. In response, the tracking system generates z-velocities, i.e., velocities along the beam direction, which are based on the detected beat signals.

In the implementations described herein, the signals are considered for the beams in the center (i.e., HD) array 350. Nevertheless, even with the added beams 340(1,2) in the center array 350, there may not be enough samples to determine the x-velocity.

Accordingly, the LIDAR data acquisition manager 130 of the tracking system 120 may perform an interpolation operation 470 on LIDAR data 142 from z-velocities at successive times T1 and T2 as deduced from beam energy received by the detector 180. Through such an interpolation operation 470, the LIDAR data acquisition manager 130 may then provide a comparison of the deviations as predicted by the object velocity at time T2 determined at the same positions along the x-direction. Such positions are illustrated in FIG. 4 as circles in interpolated center array 420(1), which corresponds to time T1, and interpolated center array 420(2), which corresponds to time T2.

The LIDAR data acquisition manager 130 may then begin the process of comparing the differences in the z-positions between the interpolated center arrays 420(1) and 420(2) at each interpolation point. In some arrangements, the LIDAR data acquisition manager 130 performs a prediction operation on the raw LIDAR data at time T1 to produce predicted z-positions at time T2 rather than T1. In this case (and the case for the subsequent discussion below), the prediction operation involves estimating the movement along the z-direction based on the velocity v_{z} in the z-direction. In some implementations, the median velocity in the z-direction is used to determine the adjustment to the z-position at each raw data point along the interpolated center array 420(1). After the LIDAR data acquisition manager 130 performs the prediction operation, the LIDAR data acquisition manager 130 then performs the interpolation of the z-position data.

With the predicted and actual z-positions at each interpolation point along the interpolated center arrays 420(1) and 420(2), the LIDAR data acquisition manager 130 may then evaluate the differences in these z-positions 450 to determine an adjustment to the beam positions for lock-on tracking. In some implementations, the adjustment in the x-positions is determined based on the position along the x-direction in which the difference between predicted and actual z-positions 450 is a minimum.

In some implementations, the LIDAR data acquisition manager 130 computes this difference 450 by performing correlation operations between the predicted and actual z-positions at each point along the interpolated center arrays 420(1) and 420(2). Such a correlation operation involves generating a cross-correlation between the predicted and actual z-positions as described above. In some implementations, the predicted and actual z-positions are deviations from a mean predicted z-position.

In some implementations, the LIDAR data acquisition manager 130 computes determines the minimum difference between predicted and actual z-positions 450 by generating a continuous function that produces a difference between a predicted and an actual z-position at each position along the x-direction. In some implementations, the position correction manager 144 generates this continuous function by a quadratic interpolation process in which the continuous function between each of the given points along the scan line 420(2) is assumed to have a quadratic behavior in the x-position.

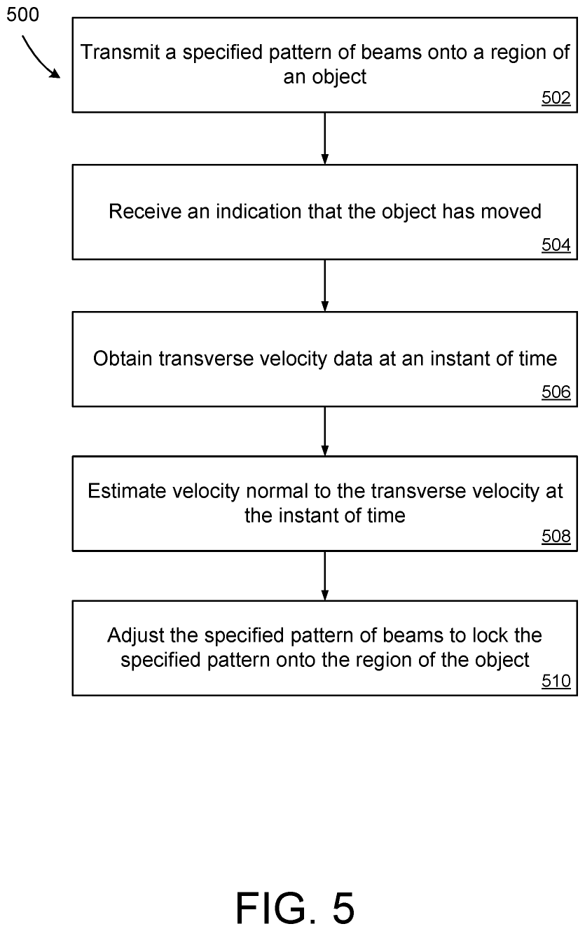

FIG. 5 illustrates an example method 500 of performing a lock-on tracking of an object using LIDAR only according to the above-described techniques. The method 500 may be performed by constructs described in connection with FIG. 1, which can reside in memory 126 of the tracking system 120 and can be executed by the processing circuitry 124.

At 502, the tracking system 120 transmits a specified pattern of beams of electromagnetic radiation (e.g., pattern 320) along a beam direction onto a region of an object, the specified pattern including a plurality of beams arranged over a grid of points mapped to the region, the plurality of beams being stationary when the region is fixed at a location in space.

At 504, the tracking system 120 receives movement indication data (e.g., a change in the beat signal as represented by doppler data 136) representing an indication that the object has moved from the location in space.

At 506, the tracking system 120 obtains transverse velocity data indicating a velocity of the object in the beam direction at an instant of time.

At 508, the tracking system 120 generates an estimate of a velocity of the object in a direction normal to the beam direction at the instant of time based on the velocity of the object in the beam direction at the instant of time.

At 510, the tracking system 120 adjusts the specified pattern of beams according to the estimate of the velocity of the object in the direction orthogonal to the beam direction to lock the specified pattern of beams onto the region of the object.

In some implementations, one or more portions of the components shown in, for example, the tracking system 120 in FIG. 1 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the tracking system 120 can be, or can include, a software module configured for execution by at least one processor (not shown). In some implementations, the functionality of the components can be included in different modules and/or different components than those shown in FIG. 1.

In some embodiments, one or more of the components of the tracking system 120 can be, or can include, processors configured to process instructions stored in a memory. For example, the LIDAR data acquisition manager 130 (and/or a portion thereof) can be a combination of a processor and a memory configured to execute instructions related to a process to implement one or more functions.

Although not shown, in some implementations, the components of the tracking system 120 (or portions thereof) can be configured to operate within, for example, a data center (e.g., a cloud computing environment), a computer system, one or more server/host devices, and/or so forth. In some implementations, the components of the tracking system 120 (or portions thereof) can be configured to operate within a network. Thus, the tracking system 120 (or portions thereof) can be configured to function within various types of network environments that can include one or more devices and/or one or more server devices. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can have portions based on various protocols such as Internet Protocol (IP) and/or a proprietary protocol. The network can include at least a portion of the Internet.

In some implementations, a memory can be any type of memory such as a random-access memory, a disk drive memory, flash memory, and/or so forth. In some implementations, the memory can be implemented as more than one memory component (e.g., more than one RAM component or disk drive memory) associated with the components of the system 100.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device (computer-readable medium, a non-transitory computer-readable storage medium, a tangible computer-readable storage medium) or in a propagated signal, for processing by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be processed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the processing of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A method comprising:
transmitting, by processing circuitry, a specified pattern of beams of electromagnetic radiation along a beam direction onto a region of an object, the specified pattern including a plurality of beams arranged over a grid of points mapped to the region, the plurality of beams being stationary when the region is fixed at a location in space;
receiving, by the processing circuitry, movement indication data representing an indication that the object has moved from the location in space;
obtaining, by the processing circuitry, transverse velocity data indicating a velocity of the object in the beam direction at an instant of time;
generating, by the processing circuitry, an estimate of a velocity of the object in a direction normal to the beam direction at the instant of time based on the velocity of the object in the beam direction at the instant of time; and
adjusting, by the processing circuitry, the specified pattern of beams according to the estimate of the velocity of the object in the direction orthogonal to the beam direction to lock the specified pattern of beams onto the region of the object.

2. The method as in claim 1, wherein transmitting the specified pattern of beams of electromagnetic radiation includes:
forming a first array of beams along a second direction orthogonal to the beam direction;
forming a second array of scanning beams along the second direction and shifted from the first array of scanning beams in a first direction orthogonal to the beam direction;
forming a center beam between the first array of beams and the second array of beams; and
identifying, as the specified pattern, a specified subarray of the first array of beams, a specified subarray of the second array of beams, and the center beam, a central beam of the specified subarray of the first array of beams, a central beam of the specified subarray of the second array of beams, and the center beam being colinear and forming a central array of beams.

3. The method as in claim 2, further comprising:
performing a first interpolation operation on two beams of the specified subarray of the first array of beams to produce a first interpolated beam of the center array of beams; and
performing a second interpolation operation on two beams of the specified subarray of the first array of beams to produce a second interpolated beam of the center array of beams.

4. The method as in claim 2, wherein obtaining the transverse velocity data includes:
receiving a transverse position of the beams of the central array of beams at the instant of time and at an earlier time;
generating a difference between the transverse position of the beams at the earlier time and the transverse position of the beams at the instant of time; and
generating, as the velocity of the object in a transverse direction at the instant of time, a ratio of the difference and a difference between the instant of time and the earlier time.

5. The method as in claim 4, wherein generating the estimate of a velocity of the object in the direction normal to the beam direction at the instant of time includes:
performing a prediction operation to produce predicted transverse positions of the beams of the central array of beams at the instant of time;
generating a difference in the transverse position of the beams of the central array of beams and the predicted transverse positions of the beams of the central array of beams at the instant of time; and
producing, as the estimate, the position along the first direction at which the difference in transverse position is a minimum.

6. The method as in claim 5, wherein the difference is a least-squares difference.

7. The method as in claim 5, wherein performing the prediction operation includes:
performing an interpolation operation on the transverse positions of the beams of the central array of beams to produce interpolated transverse positions of the beams of the central array of beams.

8. A computer program product comprising a nontransitory storage medium, the computer program product including code that, when executed by processing circuitry of a computer, causes the processing circuitry to perform a method, the method comprising:
transmitting a specified pattern of beams of electromagnetic radiation along a beam direction onto a region of an object, the specified pattern including a plurality of beams arranged over a grid of points mapped to the region, the plurality of beams being stationary when the region is fixed at a location in space;
receiving movement indication data representing an indication that the object has moved from the location in space;
obtaining transverse velocity data indicating a velocity of the object in the beam direction at an instant of time;
generating an estimate of a velocity of the object in a direction normal to the beam direction at the instant of time based on the velocity of the object in the beam direction at the instant of time; and
adjusting the specified pattern of beams according to the estimate of the velocity of the object in the direction orthogonal to the beam direction to lock the specified pattern of beams onto the region of the object.

9. The computer program product as in claim 8, wherein transmitting the specified pattern of beams of electromagnetic radiation includes:
forming a first array of beams along a second direction orthogonal to the beam direction;
forming a second array of scanning beams along the second direction and shifted from the first array of scanning beams in a first direction orthogonal to the beam direction;
forming a center beam between the first array of beams and the second array of beams; and
identifying, as the specified pattern, a specified subarray of the first array of beams, a specified subarray of the second array of beams, and the center beam, a central beam of the specified subarray of the first array of beams, a central beam of the specified subarray of the second array of beams, and the center beam being colinear and forming a central array of beams.

10. The computer program product as in claim 9, further comprising:
performing a first interpolation operation on two beams of the specified subarray of the first array of beams to produce a first interpolated beam of the center array of beams; and
performing a second interpolation operation on two beams of the specified subarray of the first array of beams to produce a second interpolated beam of the center array of beams.

11. The computer program product as in claim 9, wherein obtaining the transverse velocity data includes:
receiving a transverse position of the beams of the central array of beams at the instant of time and at an earlier time;
generating a difference between the transverse position of the beams at the earlier time and the transverse position of the beams at the instant of time; and
generating, as the velocity of the object in a transverse direction at the instant of time, a ratio of the difference and a difference between the instant of time and the earlier time.

12. The computer program product as in claim 11, wherein generating the estimate of a velocity of the object in the direction normal to the beam direction at the instant of time includes:
performing a prediction operation to produce predicted transverse positions of the beams of the central array of beams at the instant of time;
generating a difference in the transverse position of the beams of the central array of beams and the predicted transverse positions of the beams of the central array of beams at the instant of time; and
producing, as the estimate, the position along the first direction at which the difference in transverse position is a minimum.

13. The computer program product as in claim 12, wherein the difference is a least-squares difference.

14. The computer program product as in claim 12, wherein performing the prediction operation includes:
performing an interpolation operation on the transverse positions of the beams of the central array of beams to produce interpolated transverse positions of the beams of the central array of beams.

15. An electronic apparatus, comprising:
memory; and
controlling circuitry coupled to the memory, the controlling circuitry being configured to:
transmit a specified pattern of beams of electromagnetic radiation along a beam direction onto a region of an object, the specified pattern including a plurality of beams arranged over a grid of points mapped to the region, the plurality of beams being stationary when the region is fixed at a location in space;
receive movement indication data representing an indication that the object has moved from the location in space;
obtain transverse velocity data indicating a velocity of the object in the beam direction at an instant of time;
generate an estimate of a velocity of the object in a direction normal to the beam direction at the instant of time based on the velocity of the object in the beam direction at the instant of time; and
adjust the specified pattern of beams according to the estimate of the velocity of the object in the direction orthogonal to the beam direction to lock the specified pattern of beams onto the region of the object.

16. The electronic apparatus as in claim 15, wherein the controlling circuitry configured to transmit the specified pattern of beams of electromagnetic radiation is further configured to:
form a first array of beams along a second direction orthogonal to the beam direction;
form a second array of scanning beams along the second direction and shifted from the first array of scanning beams in a first direction orthogonal to the beam direction;
form a center beam between the first array of beams and the second array of beams; and
identify, as the specified pattern, a specified subarray of the first array of beams, a specified subarray of the second array of beams, and the center beam, a central beam of the specified subarray of the first array of beams, a central beam of the specified subarray of the second array of beams, and the center beam being colinear and forming a central array of beams.

17. The electronic apparatus as in claim 16, wherein the controlling circuitry is further configured to:
perform a first interpolation operation on two beams of the specified subarray of the first array of beams to produce a first interpolated beam of the center array of beams; and
perform a second interpolation operation on two beams of the specified subarray of the first array of beams to produce a second interpolated beam of the center array of beams.

18. The electronic apparatus as in claim 16, wherein the controlling circuitry configured to obtain the transverse velocity data is further configured to:
receive a transverse position of the beams of the central array of beams at the instant of time and at an earlier time;
generate a difference between the transverse position of the beams at the earlier time and the transverse position of the beams at the instant of time; and
generate, as the velocity of the object in a transverse direction at the instant of time, a ratio of the difference and a difference between the instant of time and the earlier time.

19. The electronic apparatus as in claim 18, wherein the controlling circuitry configured to generate the estimate of a velocity of the object in the direction normal to the beam direction at the instant of time is further configured to:
perform a prediction operation to produce predicted transverse positions of the beams of the central array of beams at the instant of time;
generate a difference in the transverse position of the beams of the central array of beams and the predicted transverse positions of the beams of the central array of beams at the instant of time; and
produce, as the estimate, the position along the first direction at which the difference in transverse position is a minimum.

20. The electronic apparatus as in claim 19, wherein the controlling circuitry configured to perform the prediction operation is further configured to:
perform an interpolation operation on the transverse positions of the beams of the central array of beams to produce interpolated transverse positions of the beams of the central array of beams.
